(19) United States
(12) Patent Application Publication
(10) Pub. No.: US 2012/0156544 A1
(43) Pub. Date: Jun. 21, 2012

(54) CONTACTING ELEMENT

(75) Inventors: Tim Schaefer, Niedersachswerfen (DE); Andreas Gutsch, Luedinghausen (DE); Walter Lachenmeier, Sankt Augustin (DE)

(73) Assignee: Li-Tec Battery GmbH, Kamenz (DE)

(21) Appl. No.: 13/202,497

(22) PCT Filed: Feb. 11, 2010
(86) PCT No.: PCT/EP2010/000857

§ 371 Date: Mar. 6, 2012

(30) Foreign Application Priority Data
Feb. 20, 2009 (DE) 10 2009 009 923.9

(51) Int. Cl. H01M 2/26; H01R 43/16; H01R 4/28; H01M 6/42

(52) U.S. Cl. 429/121; 29/623.1; 29/874; 439/754

(57) ABSTRACT

The invention relates to a contacting element (1) for electrically connecting a contact connection (18) of an electric cell, in particular a battery cell (22), comprising at least one deformation section (2) and at least two clamping edges (9) which are each supported at opposing end sections (4) of the at least one deformation section (2).

Priority application DE 10 2009 009 923.9 is fully incorporated by reference into the present application.

The present invention relates to a contacting element for electrically connecting a contact connection of an electric cell, and to a method for producing said element. The present invention further relates to a battery arrangement having multiple electric cells and to a method for assembling such a battery arrangement.

The present invention relates both to primary batteries, i.e. non-rechargeable electric energy stores, and to so-called secondary batteries or accumulators, which are rechargeable. In the context of the invention the term electric cell or battery will be used for simplicity. The electric cells and battery arrangements cited here are particularly suitable for use in electrically operated motor vehicles. As such the contacting element according to the invention essentially serves to connect a battery cell either to external units, e.g. consumers, or to connect multiple electric cells to each other, or both purposes at once.

KR 10 2005 004 9835 A discloses a cover unit for a secondary battery which uses an arrangement made of a shape memory material as an actuator for breaking an electrical circuit.

A similar electrical circuit breaking unit for an electrochemical cell is known from DE 698 35 613 T2. In this case a current flow through the cell is prevented when the temperature or the gas pressure in the cell rises excessively.

The object of the present invention is to provide an improved contacting element for electrically connecting a contact connection of an electric cell. A further object of the present invention is to provide an improved battery arrangement comprising a contacting element. In addition, an object of of the present invention is to provide a method for producing a contacting element and a battery arrangement.

The object of the present invention is achieved by means of a contacting element for electrically connecting a contact connection of an electric cell, in particular a battery cell, comprising a deformation section and at least two clamping edges, which are each supported at opposing end sections of the at least one deformation section.

The term support is used to mean that a force acting on one of the clamping edges is directly or indirectly transmitted to the corresponding end section. To this extent this is intended to mean both a direct support as well as an indirect support. Other sections which transmit the force stream necessary to provide the support may also be situated between the clamping edges and the end sections. The deformation section has the property that it can change its shape, possibly while providing a force. This leads to a change in the relative position of the two opposing end sections of the deformation section. Since the two clamping edges are supported at the end sections, their relative position to one another is also effected by a change in shape of the deformation section. In particular, the deformation section can be changed in such a manner that the two clamping edges move towards one another and therefore facilitate a clamping of a contact connection arranged between two clamping edges, in particular of an electrode or a cable lug. Due to the clamping a sufficiently stable connection is produced between the contacting element and the contact connection.

The deformation section is preferably produced from a einem shape memory material. Objects which are produced from a shape memory material have the capability to change their shape in accordance with external factors, for example the temperature or magnetic field strengths. Thus, for example, by applying heat the deformation section can be changed back to an original shape in which the contacting element makes contact to a contact connection of an electric cell. This means of making contact is particularly secure and reliable and furthermore, requires no special tools apart from a heat source. Multiple contacting units which are arranged in a battery arrangement can thereby be changed back into their original shape at the same time by activation of a single heat source, and thus establish the contact closure.

Preferably, the contacting element has two clamping edges, wherein a first clamping edge is supported relative to a first end section of the deformation section and a second clamping edge relative to a second end section of the deformation section.

The end sections are preferably arranged on opposing sides of the deformation section. Preferably, the deformation section changes its shape, in particular its axial elongation, under the action of heat. The heating action can in principle be effected by applying electric current. Due to the change in its shape under the action of heat, the relative position to each other of the two end sections can be changed directly. In particular, the distance between two opposing end sections when the deformation section changes shape can be changed. This means that the relative position, in particular the distance between two clamping edges, is affected at the same time. By a change in shape which causes the clamping edges to come closer together, a contact connection can be clamped between the clamping edges, for example.

Preferably, the contacting element has at least one receiving chamber for receiving a contact connection, in particular an electrode. The contact connection can be inserted into the receiving chamber. The receiving chamber is preferably open in one direction. Preferably after the heat treatment, the contact connection is then clamped in the receiving chamber by the two clamping edges and thereby fixedly connected to the contacting element.

In doing so a clamping edge preferably forms a boundary of the receiving chamber. The receiving chamber can also be bounded by means of two clamping edges, however. This allows a compact construction.

The deformation section can have multiple, in particular four, deformation tabs. The deformation tabs thus form the actual actuators, which preferably change their shape under the action of heat. With a suitable arrangement of these deformation tabs their change of shape causes a change in the axial extent of the deformation section.

The contacting element preferably has a out-of round, in particular rectangular, in particular square cross-section. Due to the non-round cross-section, after twisting relative to a contact connection the contacting element can be made to axially overlap with this contact connection. In particular with angled cross-sections, which leads in particular to a parallelipipedal contacting element, the contact connection can come to overlap with an angled edge of the preferably parallelipipedal contacting element. For this purpose the contacting element preferably has an incision in the angled edge. This incision can at least partially form the receiving chamber.

In a first preferred embodiment the deformation section reduces its axial elongation under the action of heat. If the deformation section has one or more deformation tabs, the deformation tabs bend when heat is applied. In an alternative preferred embodiment the deformation section can increase its axial elongation under the action of heat. If the deformation section has multiple deformation tabs, these are stretched when heat is applied.

In a preferred embodiment the contacting element can be integrally designed. This reduces the effort required both in the production of the contacting element and in the mounting of the contacting element into the battery arrangement.

A contacting element can preferably additionally have two deformation sections each with two end sections, wherein a clamping edge is supported at each end section. The word support means both a direct and an indirect support. Altogether therefore, four end sections and a total of four clamping edges are produced. Since one contact connection can be connected between each two clamping edges, this results in two connection possibilities for connecting a contact connection. For example, with this arrangement contact connections of different battery cells can be connected together. An end section of a deformation section is preferably directly supported on one end section of another deformation section. This produces a series connection of two deformation sections. This means that the deformations of the respective deformation sections, in particular their axial extensions, add together to form a total deformation or total extension respectively. In addition, the force of the respective deformation sections which is released by the deformation adds up to a total force which acts on the contact connections seated between two different pairs of clamping edges.

In a preferred configuration a contacting element has at least one support section, which is at least indirectly supported relative to at least one of the end sections. On one support section, a clamping edge can be at least indirectly supported in turn. The support section therefore represents a means for directly supporting a clamping edge on an end section. In particular when the spatial arrangement of the clamping edges requires that two opposing clamping edges are both locally arranged on the same side of a deformation section, a force deflection by means of one or more support sections is necessary in order to ensure the necessary support of the clamping edge relative to the other end section of the deformation section. The support section can also be fixedly connected to one of the end sections, in particular integrally constructed with the end section.

The support section is in this case preferably aligned along a deformation direction of the deformation section. Due to the common alignment of the support section with the deformation direction the support section can absorb forces which also act in alignment with the support section. The support section can project from one end section in the direction of the other end section.

Preferably, the support section itself comprises at least one of the clamping edges. In addition, the support section can have a bend along a bending line, wherein the bending line extends parallel to a deformation direction of the deformation section. Due to the bend along a bending line the area moment of inertia of the support section increases, which leads to an increase in the buckling resistance of the support section. This leads further to an increase in the loading capacity at constant cross-sectional thickness, or alternatively to a reduction in the cross-sectional thickness at constant loading capacity. Overall this means that the contacting element can be dimensioned to be smaller and/or lighter. The parallel alignment is to be understood as an approximate guideline.

Deviations from an exactly parallel alignment are therefore also covered by the term “parallel”.

In another embodiment the contacting element has a deformation body and a clamping frame which is separate from it, wherein the deformation body forms the deformation section and the clamping frame forms the support section. This bifurcation into two parts offers the possibility to optimally tune each of the components, namely the deformation body and the clamping frame, to their function. It is thus the main function of the deformation body, in response to an appropriate external signal, for example an application of heat, to undergo a certain change in shape which manifests itself in particular in a change in the distance between two end sections. This change in distance apart essentially results in either a tensile force or a compressive force, which is provided by the deformation body. The clamping frame by contrast is preferably intended to apply the appropriate counterforce, i.e. either a compressive force or a tensile force, which counteracts the force of the deformation body. Due to this, each of the two components, namely the deformation body and the clamping frame, can be specifically designed for a type of loading, namely tensile force or compressive force.

The deformation body is preferably held within the clamping frame. The clamping frame then represents in particular a guide for the deformation body. The change in shape of the deformation body can be then be directed specifically in one direction, which makes the contacting element overall more robust. Furthermore, despite the two-piece construction the deformation body and clamping frame form an easily manageable unit, which is advantageous for installing a battery arrangement. The clamping frame preferably has a cross-section that corresponds to a cross-section of the deformation body. Of course, the deformation body, when considered in cross-section, is somewhat smaller than the clamping frame, so that the deformation body can be seated inside the clamping frame with a certain amount of play. Preferably, the cross-section of the clamping frame and the cross-section of the deformation body is rectangular, in particular square.

So that the clamping frame can receive the deformation body, the clamping frame is preferably sleeve-shaped. The clamping frame is in this case preferably produced from a bent sheet of metal and in the centre has a receiving chamber for receiving the deformation body.

Preferably, the clamping frame has at least one, in particular one or two, clamping edges. With the clamping edge, the support frame can be brought directly in contact with a contact connection which it can then clamp relative to another clamping edge, in particular of the deformation body. If the clamping frame has two clamping edges, which are arranged in particular at different ends of the support frame, multiple, in particular two contact connections can be clamped relative to the deformation body.

The clamping frame can have an inward facing support edge. in particular if the deformation body is only supported relative to a single contact connection and only relative to one corresponding clamping edge of the clamping frame, the support edge serves to provide additional support for the deformation body on the opposite side. Overall, the deformation body is thus supported within the clamping frame from two sides, so that no additional support needs to be provided by external components.

The object of the present invention is further achieved by a battery arrangement comprising at least one battery module, wherein at least one contact connection, in particular one electrode, of the battery module is connected by means of a contacting element of the above mentioned type.

The contact connection preferably has a through hole with a through hole cross-section, wherein the through hole cross-section corresponds to the cross-section of the contacting element. Of course, the contacting element is somewhat smaller in cross-section than the through hole of the contact connection, so that the contacting element can be inserted into the through hole of the contact connection. The contact connection can thereby be brought into current-carrying connection with the contacting element.

Further preferably, the through hole cross-section of the through hole of the contact connection is out-of round, in particular rectangular, in particular square. The advantages already cited above are obtained with the non-round cross-sectional shape.

In addition the object is achieved by a method for mounting an aforementioned battery arrangement, comprising the following method steps:
stacking an electric cell on top of another electric cell,
inserting a contacting element into a through hole of an electric cell,
twisting the contacting element about a twisting angle,
activating the shape change of the deformation section.

The electric cells are arranged next to one another so as to save space, possibly with the interposition of thermally conducting elements. The contacting is effected via the contacting element, which is arranged in a space-saving manner in a through hole of the electric cells. Since the through holes of the electric cells are preferably aligned with one another, one contacting element can be used for connecting multiple electric cells together. By twisting the contacting element after its insertion, a contact connection, in particular an electrode, of an electric cell can be positioned so that it axially overlaps a receiving chamber of the contacting element. On the one hand this secures the contacting element axially in its position inside the through hole. On the other, the contact connection thus comes to overlap two clamping edges of the contacting element, so that at this point an electrically conducting connection can be produced between the contact connection and the contacting element. The activation of the shape change of the deformation section, in particular a treatment of the contacting element with heat, has the effect that the contacting element, in particular its deformation section, is brought into a form in which the clamping sections of the contacting element clamp the contact connection of the electric cell in place and in doing so the electrical connection between the electric cell and the contacting element is permanently established.

Preferably, the twisting angle has a value between 10° and 80°, in particular between 30° and 60°, in particular approximately 45°.

In addition, the method can comprise the method step that the contacting element is inserted into a through hole of a cable lug. The contacting between the contacting element and the cable lug is then essentially effected identically to the contacting between the contact connection of an electric cell and the contacting element. The cable lug can be clamped together with the contact connection of an electric cell, both between two clamping edges.

After the heat treatment a guide rod can be inserted into the through hole. The guide rod ensures an exact alignment of the individual electric cells relative to one another.

In addition, the guide rod can apply pressure between outlying electric cells, so that these are firmly joined together.

The object addressed by the invention is further achieved by a method for producing a contacting element cited above, which comprises the following method steps:
stamping out a blank from a metal sheet,
bending the blank at bending lines to form a parallelepiped,
compressing the blank,
treating the blank with heat.

The compression of the blank is performed at least at certain points of the deformation section. By the heat treatment of the blank, the required shape memory properties are added to the deformation section in particular.

The invention will now be explained in further detail using the following Figures. These show:

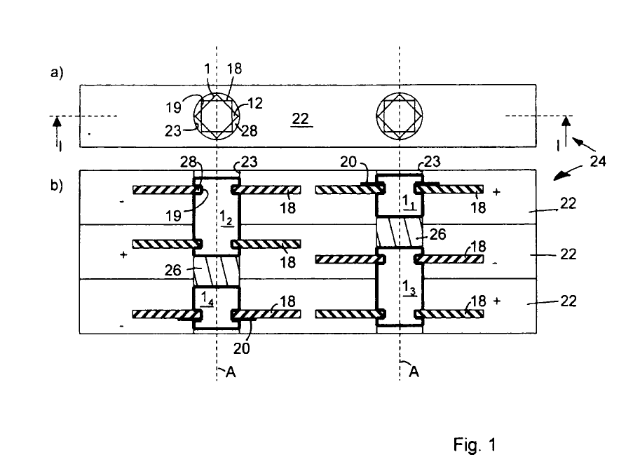

FIG. 1 a battery arrangement according to the invention comprising multiple contacting units according to the invention
a) in plan view,
b) in cross-section along the line I-I of FIG. 1;

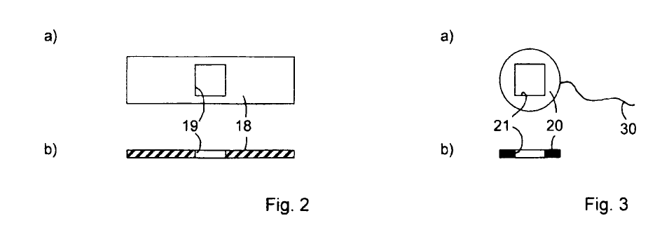

FIG. 2 an electrode of the battery arrangement according to FIG. 1 in detail
a) in plan view,
b) in cross-section along the line I-I of FIG. 1;

FIG. 3 a cable lug of the battery arrangements according to FIG. 1 in detail
a) in plan view,
b) in cross-section along the line I-I of FIG. 1;

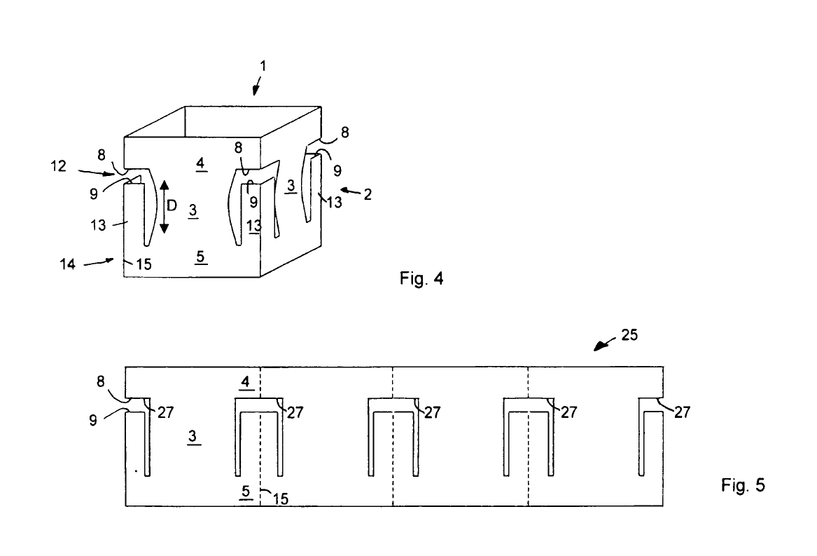

FIG. 4 a contacting element according to the invention in a first embodiment, shown in perspective;

FIG. 5 a blank for producing the contacting element according to FIG. 4 in plan view;

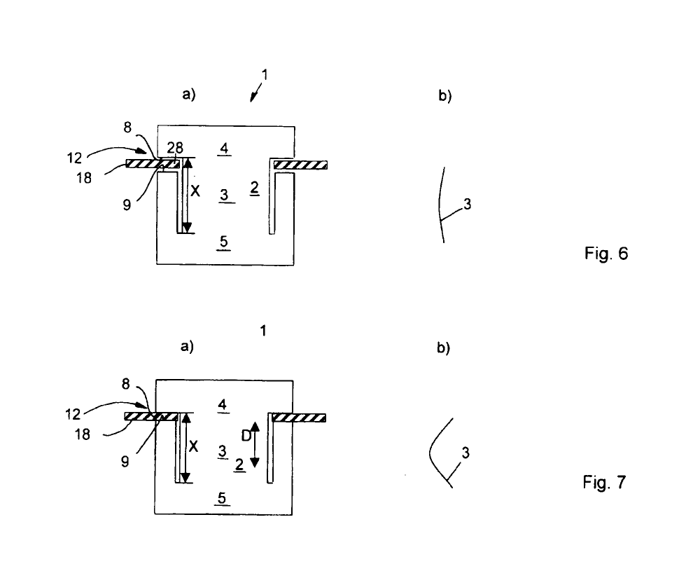

FIG. 6 the contacting element according to FIG. 4 before a change of shape, in side view,
b) in full, in cross-section along the line I-I of FIG. 1;
b) a deformation tab in detail;

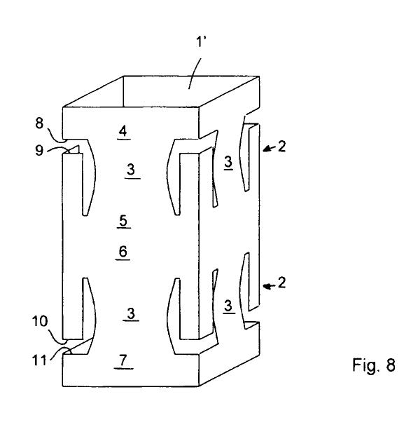

FIG. 7 the contacting element according to FIG. 4 following a change in shape in side view,
b) in full, in cross-section along the line I-I of FIG. 1;
b) a deformation tab in detail;

FIG. 8 an extension of the contacting element according to FIG. 4 shown in perspective;

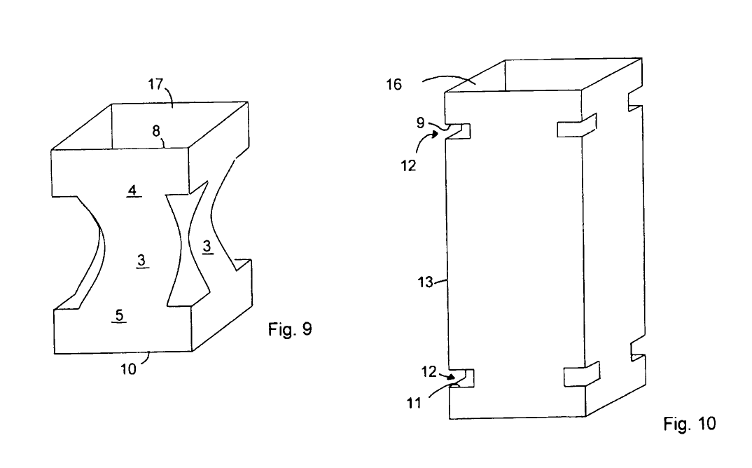

FIG. 9 a deformation body of a contacting element in a second embodiment shown in perspective;

FIG. 10 a clamping frame of the contacting element in the second embodiment shown in perspective;

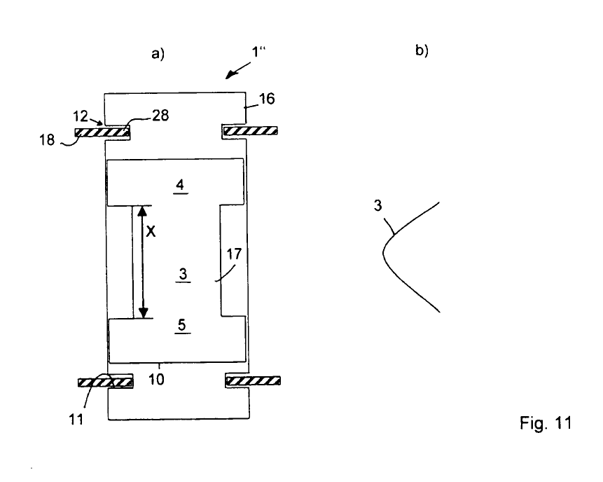

FIG. 11 the contacting element according to FIGS. 9 and 10 viewed in cross-section before a change of shape,
b) in full, in cross-section along the line I-I of FIG. 1;
b) a deformation tab in detail;

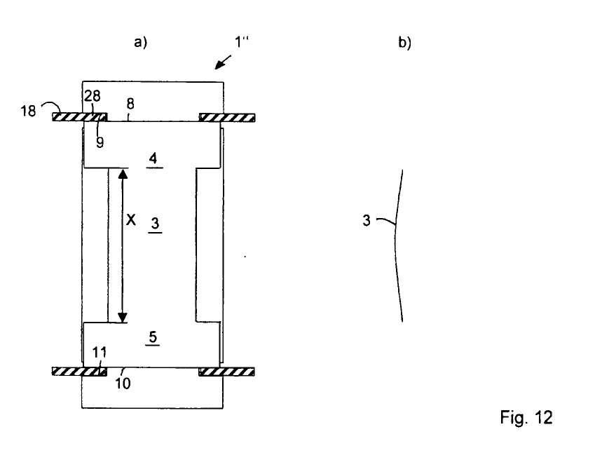

FIG. 12 the contacting element according to FIGS. 9 and 10 in cross-section, viewed [before?] a change of shape,
b) in full, in cross-section along the line I-I of FIG. 1;
b) a deformation tab in detail;

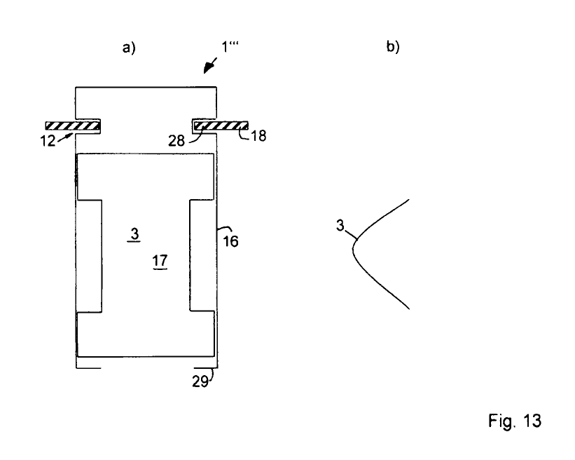

FIG. 13 a variation of the contacting element in the second embodiment before a change of shape,
b) in full, in cross-section along the line I-I of FIG. 1;
b) a deformation tab in detail;

FIG. 1 shows a battery arrangement 24 according to the invention. The battery arrangement 24 comprises three electric cells which are present in the form of battery cells 22. The battery cells are secondary cells, i.e. the battery cells are rechargeable. Such a battery arrangement can also be used for primary battery cells or fuel cells. In terms of their alignment to one another the battery cells 22 are stacked on top of one another. Each of the battery cells 22 has two through holes 23, wherein both through holes of the battery cells each aligned relative to the through holes of the other battery cell along two common bore axes A. Each of the battery cells 22 has in each case two contact connections in the form of electrodes 18, namely one cathode and one anode. The cathodes are marked by the “+” signs placed next to them. The anodes are marked by the “−” signs placed next to them.

As can be seen in particular in FIG. 2, the electrodes 18 are in the shape of plates and have a square through hole 19. The square through hole 19 is smaller than the through hole 23 of the corresponding battery cell, so that the electrode 18 protrudes into the through hole 23 of the battery cell 22. Each electrode 18 therefore has an overhang 28 projecting into the through hole 23. The contacting element 1 can be passed through the through hole 19.

Multiple contacting elements 1, four in total, are arranged inside the two through holes 23 of the battery cells 22. The contacting elements 1 are substantially sleeve-shaped and are described in more detail below. In a receiving chamber 12 which is arranged at a corner section of the contacting element 1, the overhang 28 projects into the sleeve-shaped contacting element and makes a current-carrying connection to the contacting element 1 there. On the contacting element 1 a cable lug 20 is additionally provided, which projects into the same receiving chamber 12 as the electrode 18. The cable lug 20 is electrically connected to the outside via a cable 30. In the same manner, a cable lug 20 with a cable 30 is also attached to the contacting element 14.

As can be seen from FIG. 1a, the contacting element 1 and the through hole 19 in the electrode 18 are both square in shape, these shapes substantially corresponding to each other. The square cross-section of the contacting element 1 is somewhat smaller than the through hole 19 in the electrode 18, so that the contacting element 1 can be inserted into the through hole 19. As can also be seen from FIG. 1, the contacting element 1 is rotated by approximately 45° relative to the through hole 23 of the battery cell 22. This makes it possible for the overhang 28 of the electrode 18 to project into the receiving chamber 12 of the contacting element 1, which is arranged in the corner regions of the parallelipipedal contacting element 1. Due to this connection of contacting element 1 and electrode 18, the contacting element 1 is held axially inside the through hole 23 of the battery cell 22 along the bore axis A.

In the battery arrangement 24 shown in FIG. 1 the three battery cells 22 are connected in series. A first cable lug 20 is connected via a contacting element 11 to the cathode of the top battery cell 22. The anode 18 of the top battery cell 22 is connected via a contacting element 12 to the cathode 18 of the middle battery cell 22. The anode 18 of the middle battery cell 22 is connected via a contacting element 13 to the cathode 18 of the lower battery cell 22. The anode of the lower battery cell 22 is connected by means of a contacting element 14 to the second cable lug 20. Between two contacting elements 1 an insulator 26 is in each case arranged in the through holes 23, which prevents short-circuiting of the two contacting elements. The insulator 26 also serves as a spacer between two contacting elements 1.

In FIG. 3 the cable lug 20 is shown in detail. The cable lug has a through hole 21, which has a square cross-section. The cross-section has an analogous construction to the cross-section of the through hole 19 of the electrodes 18. The contacting element can be passed through the through hole 19.

FIG. 4 shows a contacting element 1 in a first embodiment. This contacting element is suitable for use for example in the battery arrangement according to FIG. 1 and can be used there for example as contacting element 1 or 14. The contacting element 1 is produced integrally from a metal sheet. It has a deformation section 2 which comprises a total of four deformation tabs 3. Of the four deformation tabs 3 only two can be seen in FIG. 4, the others are hidden. The deformation section 2 has two opposing end sections 4, 5. The deformation sections 2 are produced from a shape memory material and be made to change their shape under the action of heat . When this occurs the deformation tabs 3, as shown later, can bend. A consequence of this is that the end sections 4, 5 move towards each other.

In addition, first clamping edges 8 and second clamping edges 9 are provided, wherein the first clamping edges 8 are situated on the first end section 4 and therefore can be supported on the first end section 4. The second clamping edges 9 are attached to a support section 13, which is in turn attached to the second end section 5. The second clamping edges 9 are therefore supported on the support section 13, which can in turn be supported on the second end section 5. The second clamping edges 9 can thus be supported indirectly on the second end section 5. The support sections 13 each have a bend 14, which extends along a bending line 15. The bending line 15 corresponds simultaneously to a bounding edge of the cube-shaped contacting element 1. While the deformation tabs 3 essentially have the capacity to change shape, the end sections and the support sections are essentially designed with dimensional stability, which also additionally applies to the following embodiments.

During the deformation of the deformation section 2, for example due to the action of heat, the contacting element changes its axial elongation along a deformation direction D. The bending lines 15 of the support sections 13 extend parallel to the deformation direction D.

FIG. 5 shows the contacting element in its flat form, or as the blank for producing the contacting element. The blank 25 is stamped out of a metal sheet, wherein in particular cut-outs 27 have been stamped out which effect the sub-division of the contacting element into the end sections, the deformation section 2 and the support sections 13. The blank is subsequently bent at the bending lines 15 into its square shape. Then, the deformation tabs 3 are compressed. The blank 25 is treated with heat, which causes the blank 25, and in particular the deformation tabs 3, to obtain the necessary shape memory properties.

With the aid of FIGS. 6 and 7 the mode of operation of the contacting element 1 will be described in more detail. The deformation section 2 can be identified, which has a first end section 4 and a second end section 5. Four deformation tabs 3 are arranged between the end sections 4, 5 in each case . Into a receiving chamber 12 formed by the first and second clamping edges 8, 9, the overhang 28 projects into the receiving chamber.

FIG. 6 shows the contacting element prior to heat treatment during the assembly process of a battery arrangement. This heat treatment is not to be confused however with the heat treatment that is used during the production of the contacting element 1 from the blank 25, as was explained with reference to FIG. 5. There are therefore two different heat treatment processes. Before the heat treatment, as can be seen in FIG. 6, the deformation tabs 3 are in an almost fully elongated form, as seen in FIG. 6b. If heat is now applied, which can also take place by passing a current, the deformation tabs 3 are deflected, as can be seen from FIG. 7b). This leads to the deformation section 2 being drawn together such that the distance X between the two end sections 4, 5 is shortened. As a result, the first clamping edges 8 move towards the second clamping edges 9 during the heat treatment, and thus clamp the electrode 18 arranged in the receiving chamber 12. This means that a fixed, current-carrying connection s produced between the contacting element 1 and the electrode 18.

FIG. 8 shows an extension of the contacting element 1 from FIG. 4. Along with the first end section 4 and the second end section 5 the contacting element 1′ has a third end section 6 and a fourth end section 7. In addition, the contacting element 1′ has a second deformation section 2, which again comprises four deformation tabs 3. Expressed in other words, the contacting element 1′ corresponds to the contacting element 1 of FIG. 4, at the end of the second end section 5 of which an identical contacting element is arranged, mirror-inverted. As a result, in addition to the first and second clamping edges 8, 9, third and fourth clamping edges 10, 11 are formed which are supported on the third end section 6 or the fourth end section 7 respectively, analogously to the contacting element 1 of FIG. 4. The contacting element 1′ can contact two electrodes 18 which are offset relative to each other, and is suitable for use, for example, as a contacting element 11 or 13, in the battery arrangement according to FIG. 1.

FIGS. 9 and 10 show another embodiment of a contacting element 1″. The contacting element in this embodiment is constructed from two pieces and comprises a deformation body 17 and a clamping frame 16, configured separately. The deformation body 17 represents the deformation section 2 and has four deformation tabs 3, on the opposing sides of which a first end section 4 and a second end section 5 are located. On the first end section 4 a first clamping edge 8 is arranged. On the second end section 5 a third clamping edge 10 is arranged.

The clamping frame 16 is essentially sleeve-shaped and has a square cross-section. The cross-section of the clamping frame 16 corresponds essentially to the cross-section of the deformation body 17, wherein the deformation body 17 viewed in cross-section is somewhat smaller, so that it fits into the clamping frame. In an upper region and a lower region the clamping frame 16 has multiple receiving chambers 12, which are formed by incisions in the bounding edges.

The sleeve-shaped clamping frame thus represents a support section 13 of the contacting elements 1″. Second clamping edges 9 and fourth clamping edges 11 are constructed on the receiving chambers 12, which can interact with the first clamping edges 8 and the third clamping edges 10 of the deformation body 17, as is described in more detail in FIG. 11.

In FIG. 11 the contacting element 1″ can be seen, which comprises a deformation body 17 according to FIG. 9 and a clamping frame 16 according to FIG. 10. The deformation body 17 is held inside the clamping frame 16, from which it is clear that that the deformation body 17 viewed in cross-section is somewhat smaller than the clamping frame 16. In the receiving chambers 12 of the clamping frame 16, the overhangs 28 of the electrodes 18 can be seen. The overhangs 28 are loosely positioned in the receiving chambers 12. The deformation tabs 3 of the deformation body 17 are bent, as can be seen from FIG. 11 b.

FIG. 12 shows the state of the contacting element 11″ after the heat treatment during the assembly of the battery arrangement according to FIG. 1 has been completed. The deformation tabs 3 are nearly fully elongated, as can be seen from FIG. 12b, so that the axial distance X from the first end section 4 to the second end section 5 becomes enlarged, relative to the state according to FIG. 11. The consequence of this is that the first clamping edge 8 which is arranged on the first end section 4, has moved towards the second clamping edge 9, which is arranged on the receiving chamber 12 of the clamping frame 16. In addition the third clamping edge 10 has moved towards the fourth clamping edge 11. Both of these lead to a clamping of the two electrodes 18 within the two receiving chambers 12.

FIG. 13 shows a in contacting element 1—which represents an extension of the contacting element 1″ according to FIGS. 9 to 12. Here, the clamping frame 16 has receiving chambers 12 for receiving overhangs 28 of an electrode 18 only in an upper region. On the lower side the clamping frame is bent around and therefore has a circumferential support edge 29, on which the deformation body 17 can be supported. The contacting element 1″ is particularly suitable for example for use as a contacting element 1, or 14 in the battery arrangement according to FIG. 1.

To assemble the battery arrangement 24 according to Figure the battery cells 22 are first stacked on top of one another, namely in such a manner that the through holes 23 of the battery are aligned cells coaxially to common bore axes A. A contacting element is then inserted into the through hole and moved into its axial position, so that the electrodes 18 are at the same axial height to the corresponding receiving chambers 12. Then the contacting element is turned through 45°, which causes the receiving chambers 12 to overlap relative to the overhangs 28 of the electrodes 18. In doing so the clamping edges 8, 9, 10, 11 of the contacting unit 1 in come to rest in contact with the electrodes 18, but still without clamping them. A small gap or amount of play between the clamping edges and the electrodes 18 can be present. Subsequently the contacting unit 1 is heat-treated, which causes the deformation section 2 to change its shape, which in particular makes the clamping edges 8, 9 and 10, 11 move towards each other and thereby clamp the electrodes 18 in the receiving chambers 12.

During this assembly process the contacting unit 11 and 14 is inserted into the through hole 21 of a cable lug 20, which is connected to the contacting element in the same way as is the electrode 18.

Finally a guide rod, not shown, is passed into the individual through holes, which ensures the alignment of the battery cells to one another over the long term.

An insulator 26 can be placed in between each two contacting units 1, which provides insulation between two contacting units 1 arranged together in a through hole. In addition the insulator 26 can serve as a mechanical spacer between two contacting units 1.

### LIST OF REFERENCE MARKS

1 contacting element
2 deformation section
3 deformation tab
4 first end section
5 second end section
6 third end section
7 fourth end section
8 first clamping edge
9 second clamping edge
10 third clamping edge
11 fourth clamping edge
12 receiving chamber
13 support section
14 bend
15 bending line
16 clamping frame
17 deformation body
18 electrode
19 through hole in electrode
20 cable lug
21 through hole in cable lug
22 battery cell
23 through hole in battery cell
24 battery arrangement
25 blank
26 insulator
27 cut-out
28 overhang
29 support edge
30 cable
31 angled edge
X distance
L axial length
D deformation direction
A bore axis

1-42. (canceled)

43. A contacting element for electrically connecting a contact connection of an electric cell, comprising:
at least one deformation section;
at least two clamping edges, which are each supported at opposing end sections of the at least one deformation section; and
at least one receiving chamber to receive a contact connection,
wherein the receiving chamber incises an angled edge of the contacting element.

44. The contacting element of claim 43, wherein the at least one deformation section comprises a shape memory material.

45. The contacting element of claim 43, wherein a first clamping edge of the at least two clamping edges is supported relative to a first end section of the deformation section, and
wherein a second clamping edge of the at least two clamping edges is supported relative to a second end section of the deformation section.

46. The contacting element of claim 43, wherein the end sections are arranged on opposing sides of the deformation section.

47. The contacting element of claim 43, wherein under action of heat, the deformation section changes its shape.

48. The contacting element of claim 43, wherein a distance between two opposing end sections is changed when the deformation section changes shape.

49. New): The contacting element of claim 43, wherein a clamping edge forms a boundary of the receiving chamber.

50. The contacting element of claim 43, wherein the contacting element has an out-of-round cross-section.

51. The contacting element of claim 43, wherein the deformation section comprises multiple deformation tabs.

52. The contacting element of claim 51, wherein the deformation tabs change their shape under action of heat.

53. The contacting element of claim 43, wherein the deformation section reduces its axial elongation under action of heat.

54. The contacting element of claim 51, wherein the deformation tabs bend under action of heat.

55. The contacting element of claim 43, wherein the deformation section increases its axial elongation under action of heat.

56. The contacting element of claim 51, wherein the deformation tabs elongate under action of heat.

57. The contacting element of claim 43, wherein the contacting element is integrally constructed.

58. The contacting element of claim 43, comprising two deformation sections each having two end sections, wherein a clamping edge is supported at each end section.

59. The contacting element of claim 58, wherein one end section of a deformation section is directly supported on one end section of another deformation section.

60. The contacting element of claim 43, comprising at least one support section which is at least indirectly supported relative to at least one of the end sections.

61. The contacting element of claim 60, wherein the support section is fixedly connected to one of the end sections.

62. The contacting element of claim 60, wherein the support section is aligned along a deformation direction of the deformation section.

63. The contacting element of claim 60, wherein the support section projects from one end section in a direction of the other end section.

64. The contacting element of claim 60, wherein the support section comprises at least one of the clamping edges.

65. The contacting element of claim 60, wherein the support section comprises two clamping edges.

66. The contacting element of claim 60, wherein the support section includes a bend along a bending line, wherein the bending line extends parallel to a deformation direction of the deformation section.

67. The contacting element of claim 43, comprising a deformation body and a clamping frame which is separate therefrom.

68. The contacting element of claim 67, wherein the deformation body forms the deformation section and the clamping frame forms the support section.

69. The contacting element of claim 68, wherein the deformation body is received within the clamping frame.

70. The contacting element of claim 67, wherein the clamping frame has a cross-section that corresponds to a cross-section of the deformation body.

71. The contacting element of claim 67, wherein a cross-section of the clamping frame and a cross-section of the deformation body are rectangular.

72. The contacting element of claim 67, wherein the clamping frame is sleeve-shaped.

73. The contacting element of claim 67, wherein the clamping frame has at least one clamping edge.

74. The contacting element of claim 67, wherein the clamping frame has at least one inward facing support edge.

75. A battery arrangement, comprising:
at least one electric cell,
wherein at least one contact connection of the electric cell is connected by the contacting element of claim 43.

76. The battery arrangement of claim 75, wherein the contact connection comprises a through hole with a through hole cross-section,
wherein the through hole cross-section corresponds to a cross-section of the contacting element.

77. The battery arrangement of claim 76, wherein the cross-section of the through hole of the contact connection is rectangular.

78. A method for assembling the battery arrangement of claim 75, comprising:
stacking a first electric cell on top of a second electric cell;
inserting a contacting element into a through hole of the first electric cell;
twisting the contacting element about a twisting angle; and
activating a shape change of the deformation section.

79. The method of claim 78, wherein the twisting angle has a value between 10° and 80°.

80. The method of claim 78, further comprising:
inserting the contacting element into a through hole of a cable lug.

81. The method of claim 78, further comprising:
after activating the shape change of the deformation section, inserting a guide rod into a die through hole of the electric cell.

82. A method for producing the contacting element of claim 43, comprising:
stamping out a blank from a metal sheet, to obtain a stamped blank;
bending the stamped blank at bending lines to form a parallelepiped;
compressing the parallelepiped, to obtain a compressed blank; and
treating the compressed blank with heat.

83. The contacting element of claim 43, wherein under action of heat, the deformation section changes its shape relative to an axial elongation thereof.

84. The contacting element of claim 43, wherein the contacting element has a rectangular cross-section.

85. The contacting element of claim 43, wherein the contacting element has a square cross-section.
